(19) United States
(12) Patent Application Publication
(10) Pub. No.: US 2008/0068323 A1
(43) Pub. Date: Mar. 20, 2008

(54) INTEGRATED DISPLAY PANEL

(75) Inventor: Chien-Chuan Liao, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: NOVATEK MICROELECTRONICS CORP., Hsinchu City (TW)

(21) Appl. No.: 11/560,839

(22) Filed: Nov. 17, 2006

(30) Foreign Application Priority Data
Sep. 19, 2006 (TW) 95134559

(51) Int. Cl. G09G 3/36

(52) U.S. Cl. 345/98

(57) ABSTRACT

An integrated display panel is provided. The integrated display panel includes a video connector, a signal selector, an image scaler and a timing controller. The video connector transmits a differential signal or a video signal. The signal selector determines whether or not to receive and output the differential signal according to a micro-control information. The image scaler is coupled to the video connector or the signal selector to scale the image. The timing controller is coupled to the video connector and the image scaler to convert the signal received by the timing controller to a display data.

### CROSS-REFERENCE TO RELATED APPLICATION

This application claims the priority benefit of Taiwan application serial no. 95134559, filed Sep. 19, 2006. All disclosure of the Taiwan application is incorporated herein by reference.

### BACKGROUND OF THE INVENTION

1. Field of the Invention

The present invention relates to a display panel, and more particularly to an integrated display panel that may be used together with a liquid crystal display (LCD) control module or a peripheral control module.

2. Description of Related Art

Chipsets of an LCD panel can be classified into two types, namely, control ICs and driver ICs. The control IC serves as a medium between a video input terminal (for example, a computer) and an LCD panel to receive, convert, process, and output a signal from the video input terminal. For example, the control IC adjusts the luminance, contrast, vertical position, and horizontal position of the display panel by using on screen display (OSD). The driver IC is used to image the data generated by the control IC onto the display panel. However, as for the design of the LCD panel, the market demand and cost shall both be considered. Therefore, in recent years, in consideration of the market demand and the cost performance, many researchers have exerted their efforts to design the layout of the chipsets of the LCD panel in many ways.

FIG. 1 is a block diagram of a structure of a common LCD panel. For the convenience of description, FIG. 1 further shows an LCD control module 130. Referring to FIG. 1, a common LCD 110 receives a low voltage differential signal (LVDS) S13 from a control IC 131 through a low voltage differential signal (LVDS) connector 120. The LCD control module 130 receives signals S11 and S12 from a video input terminal (not shown) through a RGB connector 133 and a digital visual interface (DVI) connector 134 respectively. Subsequently, the control IC 131 receives the signals S11 and S12 through a RGB receiver 135 and a DVI receiver 136 respectively. A peripheral control IC 132 controls the backlight and the sound volume according to commands from a microprocessor 137. An LVDS emitter 138 and an LVDS receiver 112 serve as an output/input interface between the common LCD panel 110 and the control IC 131. When displaying a frame, the common LCD panel 110 generates a display data D11 required by a driver IC 113 through a timing controller 111. After that, the driver IC 113 drives a pixel array 114 according to the display data D11.

In order to achieve a high integrity for the common LCD panel 110, a panel standard work group (PSWG) provides an intellectual LCD panel architecture, as shown in FIG. 2. For the convenience of description, FIG. 2 further shows a peripheral control module 230. The idea of an intellectual LCD panel 210 lies in that a control IC 211 and a timing controller 212 are integrated into one piece. As such, the intellectual LCD panel 210 may be connected to the peripheral control module 230 only through the visual connector 220. Thus, a DVI receiver 213 receives a signal S21 from a DVI connector 232, a RGB receiver 214 receives a signal S22 from a RGB connector 231, and a peripheral control IC 233 receives a peripheral control signal S23 from a microprocessor 215, wherein the signals S21 and S22 are generated from a video input terminal (not shown). When displaying a frame, the intellectual LCD panel 210 drives a pixel array 217 through the timing controller 212 and a driver IC 216.

However, although the intellectual LCD panel 210 enhances the cost efficiency of a display panel, it is actually restricted in practical application in many aspects. When the control IC is pre-disposed in the display panel, a firmware in the control IC has been burned and fixed onto the microprocessor, thus, in response to different clients' requirements, the intellectual LCD panels 210 must establish different inventories for different clients. In other words, although the intellectual LCD panel 210 requires a low package cost due to the high integrity, its inventory management cost is relatively high because the firmware should be changed to cater to different clients' requirements.

Additionally, on the contrary, the common LCD panel 110 without the integrity has high power consumption and a high package cost. Therefore, it is difficult for the LCD panel to find a balance point between the market demand and the cost performance.

### SUMMARY OF THE INVENTION

The present invention is directed to providing an integrated display panel, which achieves the balance between the market demand and the cost performance by combining the functions of the common display panel and the intellectual display panel.

The present invention provides an integrated display panel, which comprises a video connector, a signal selector, an image scaler and a timing controller. The video connector is used to transmit a differential signal or a video signal. The signal selector is used to determine whether to receive and output the differential signal or not according to a micro-control information. The image scaler is used to scale the image. The timing controller is used to convert the signal received by the timing controller to a display data.

In an embodiment of the present invention, the video signal is an analog video signal, and the integrated display panel further comprises a video receiver for receiving the analog video signal, wherein the video receiver comprises a RGB receiver.

In an embodiment of the present invention, the video signal is a digital video signal, and the integrated display panel further comprises a video receiver for receiving the digital video signal, wherein the signal selector further determines whether or not to receive and output the digital video signal according to a micro-control information, and the video receiver comprises a digital visual interface (DVI) receiver.

In an embodiment of the present invention, the integrated display panel further comprises a video data receiver for receiving a differential signal, wherein the video data receiver comprises a low voltage differential signal (LVDS) receiver.

In an embodiment of the present invention, the integrated display panel further comprises a microprocessor for generating the micro-control information according to a mode switching signal, wherein the video connector generates the mode switching signal according to the signal transmitted by the video connector.

In an embodiment of the present invention, the integrated display panel further comprises a substrate, wherein the video connector, the signal selector, the image scaler, and the timing controller are disposed on the substrate.

According to another aspect of the present invention, another integrated display panel comprising a video connector, a signal selector, an image scaler, and a timing controller is provided. The video connector is used for transmitting a differential signal or a video signal. The signal selector is used for determining whether or not to receive and output the differential signal or the video signal according to a micro-control information. The image scaler is used for scaling an image. The timing controller is used for selecting one from the signals received by the timing controller and converting the selected signal into a display data.

In an embodiment of the present invention, the integrated display panel further comprises a video receiver for receiving video signals from the video connector or the signal selector. When the video signals include analog video signals and digital video signals, the video receivers include an analog video receiver and a digital video receiver, wherein the analog video receiver is used for receiving the analog video signals and the digital video receiver is used for receiving the digital video signals.

In an embodiment of the present invention, the integrated display panel further comprises a video data receiver for receiving a differential signal, wherein the video data receiver comprises an LVDS receiver.

In an embodiment of the present invention, the integrated display panel further comprises a substrate, wherein the video connector, the signal selector, the image scaler, and the timing controller are disposed on the substrate.

In the present invention, the signal selector is controlled through the mode switching signal, such that the integrated display panel in the present invention achieves the functions of a common display panel and an intellectual display panel, thus meeting the market demand and cost performance requirements more efficiently.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

FIG. 1 is a block diagram of a structure of a common LCD panel.

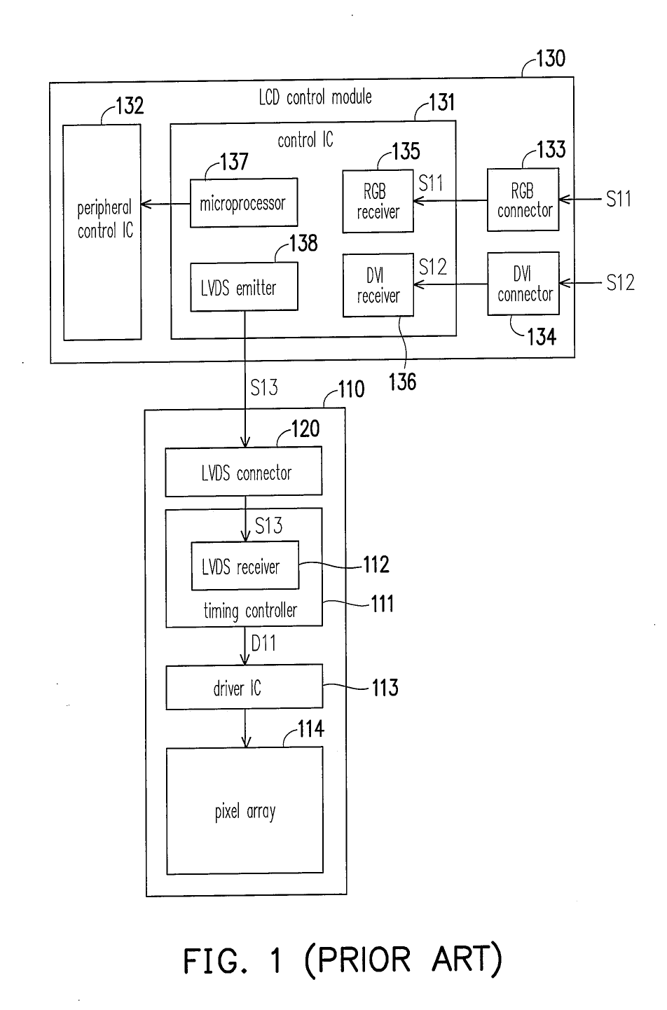

FIG. 2 is a block diagram of a structure of an intellectual LCD panel.

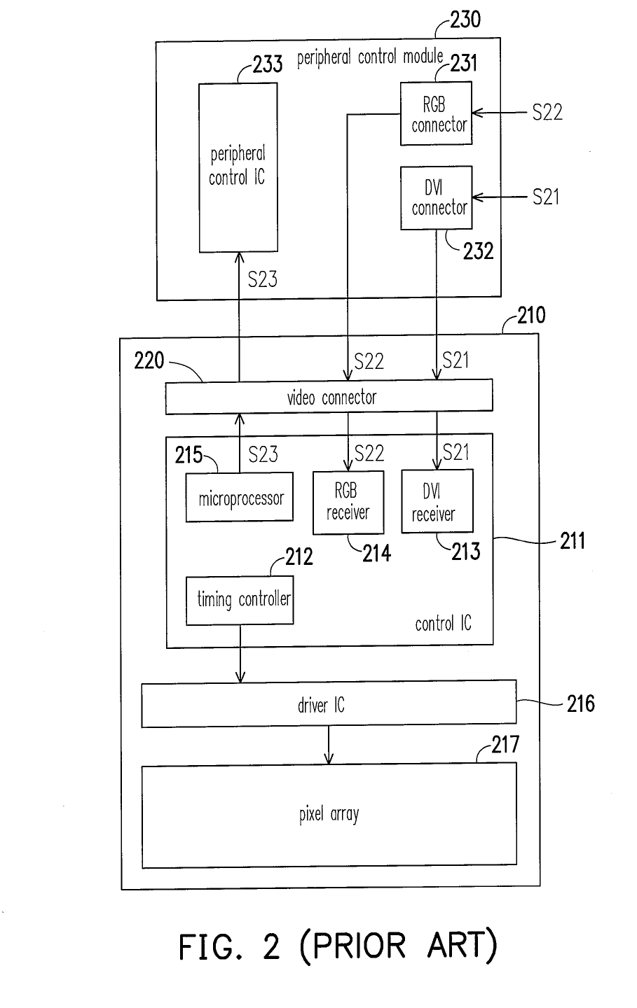

FIG. 3 is a block diagram of a structure of an integrated display panel according to an embodiment of the present invention.

FIG. 4 is a block diagram of a structure of an integrated display panel according to another embodiment of the present invention.

FIG. 5 is a block diagram of a structure of an integrated display panel according to still another embodiment of the present invention.

### DESCRIPTION OF EMBODIMENTS

The main technical features of the present invention are described as follows. Through the transmission of a differential signal or a video signal, the present invention can functions as a common display panel or an intellectual display panel. When the integrated display panel of the present invention functions as the common display panel, it can be applied in different types of LCD control modules to meet different client levels. Furthermore, the integrated display panel of the present invention may be switched to the function of the intellectual display panel to efficiently reducing the system cost. The integrated display panel of the present invention will be described below through some examples, but these are not intended to limit the scope of the present invention. Modifications made to the following embodiments by those skilled in the art also construed to be within the scope of the present invention.

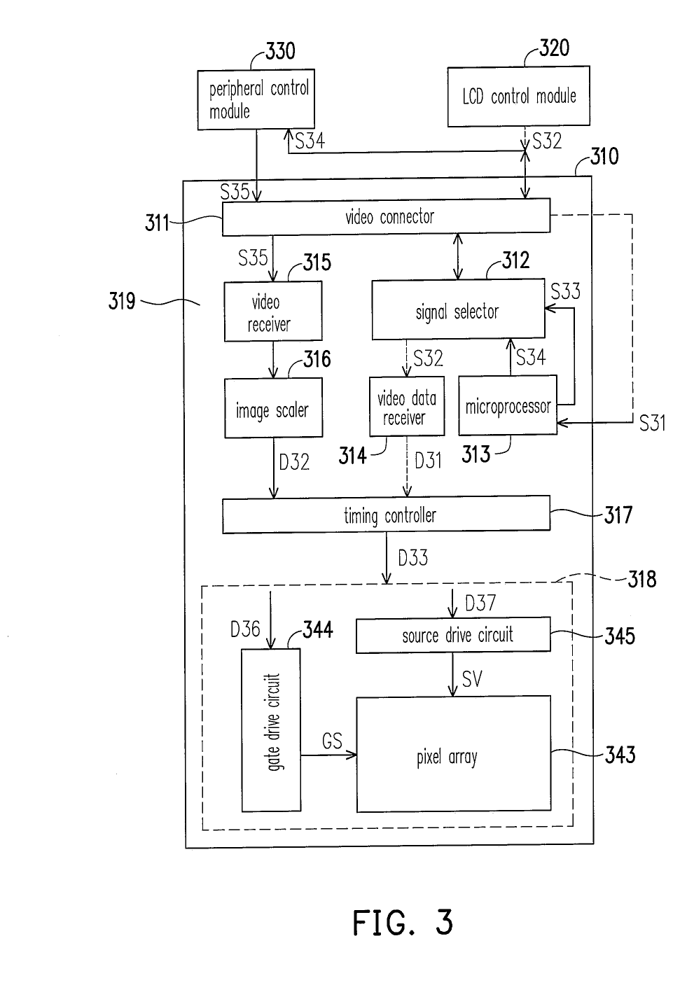

FIG. 3 is a block diagram of a structure of an integrated display panel according to an embodiment of the present invention. For the convenience of description, FIG. 3 further shows an LCD control module 320 and a peripheral control module 330. Referring to FIG. 3, an integrated display panel 310 includes a video connector 311, a signal selector 312, a microprocessor 313, a video data receiver 314, a video receiver 315, an image scaler 316, a timing controller 317, and an image display module 318. The signal selector 312 is coupled to the microprocessor 313 and the video connector 311. The video data receiver 314 is coupled to the signal selector 312. The video receiver 315 is coupled to the video connector 311. The image scaler 316 is coupled to the video receiver 315. The timing controller 317 is coupled to the video data receiver 314 and the image scaler 316. The image display module 318 is coupled to the timing controller 317.

Furthermore, the integrated display panel 310 further includes a substrate 319, wherein the video connector 311, the signal selector 312, the microprocessor 313, the video data receiver 314, the video receiver 315, the image scaler 316, the timing controller 317, and the image display module 318 are all disposed on the substrate 319.

Referring to FIG. 3, when a mode switching signal S31 is at a first logic level (such as logic 0), the integrated display panel 310 functions as a common display panel. Therefore, at this time, the integrated display panel 310 may be used together with different types of LCD control modules 320, thereby catering to different client levels. On the contrary, when the mode switching signal S31 is at a second logic level (such as logic 1), the integrated display panel 310 functions as an intellectual display panel. In other words, at this time, the integrated display panel 310 may provide the whole audio-visual function as long as it is used together with a peripheral control module 330 with simple functions. It should be noted that, the mode switching signal S31 may not only be generated by the video connector 311 according to the signal transmitted by the video connector 311, but also provided by an external device depending upon the design requirements of the integrated display panel 310.

The operation of the integrated display panel 310 is described hereinafter. When the integrated display panel 310 is switched to the function as the common display panel, the video connector 311 transmits a differential signal S32 to the signal selector 312. The microprocessor 313 generates a micro-control information S33 according the mode switching signal S31. Then, the signal selector 312 receives and outputs the differential signal S32 according to the micro-control information S33 (for example, at this time, the micro-control information S33 is at the first logic level). The video data receiver 314 receives the differential signal S32 and generates an image data D31 accordingly. Thus, the timing controller 317 converts the received image data D31 to a display data D33. Finally, the image display module 318 displays the image corresponding to the image data D33.

On the other hand, when the integrated display panel 310 is switched to the function as the intellectual display panel, the microprocessor 313 generates the micro-control information S33 and a peripheral control signal S34 according to the mode switching signal S31. At this time, the signal selector 312 receives and outputs the peripheral control signal S34 according to the micro-control information S33 (for example, the micro-control information S33 is at the second logic level). Then, the video connector 311 transmits the peripheral control signal S34 to the peripheral control module 330 and transmits the video signal S35 to the video receiver 315. Subsequently, the video receiver 315 receives the video signal S35 and the image scaler 316 scales the image corresponding to an output signal of the video receiver 315, thereby generating an image data D32. Thereby, the timing controller 317 converts the received image data D32 to a display data D33. Finally, the image display module 318 displays an image corresponding to the display data D33.

Referring to FIG. 3, the image display module 318 includes a gate drive circuit 344, a source drive circuit 345 and a pixel array 343. The display data D33 includes a gate drive data D36 and a source drive data D37. The gate drive circuit 344 is used to generate a gate signal GS for turning on/off the pixel array 343 according to the gate drive data D36, and the source drive circuit 345 is used to generate a source voltage SV for driving the pixel array 343 according to the source drive data D37.

It should be noted that the video signal is an analog video signal, and the video receiver 315 includes a RGB receiver. In addition, the video data receiver 314 includes an LVDS receiver. However, those skilled in the art may easily configure the video receiver 315 and the video data receiver 314 with other elements depending upon design requirements.

Furthermore, the integrated display panel 310 transmits the differential signal S32 and the peripheral control signal S34 through a part of the same pin of the video connector 311. In terms of application, the integrated display panel 310 is an LCD panel. The peripheral control signal S34 generated by the microprocessor 313 includes a volume control information and a backlight control information, so as to control the volume and the light source required while the frame is displayed.

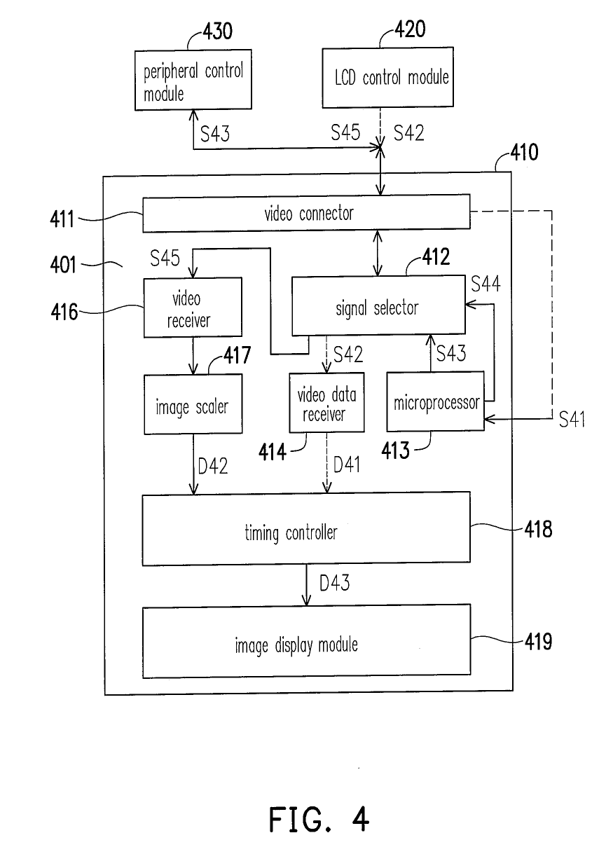

FIG.4 is a block diagram of a structure of an integrated display panel according to another embodiment of the present invention. Referring to FIG. 4, an integrated display panel 410 includes a video connector 411, a signal selector 412, a microprocessor 413, a video data receiver 414, a video receiver 416, an image scaler 417, a timing controller 418, and an image display module 419. Furthermore, FIG. 4 also shows an LCD control module 420 and a peripheral control module 430. The signal selector 412 is coupled to the microprocessor 413 and the video connector 411. The video data receiver 414 is coupled to the signal selector 412. The video receiver 416 is coupled to the signal selector 412. The image scaler 417 is coupled to the video receiver 416. The timing controller 418 is coupled to the video data receiver 414 and the image scaler 417. The image display module 419 is coupled to the timing controller 418.

The integrated display panel 410 further includes a substrate 401, wherein the video connector 411, the signal selector 412, the microprocessor 413, the video data receiver 414, the video receiver 416, the image scaler 417, the timing controller 418, and the image display module 419 are all disposed on the substrate 401.

The working principle of the embodiment in FIG. 4 is substantially the same as that of the embodiment in FIG. 3. When the integrated display panel 410 functions as the common display panel, the differential signal S42 is transmitted to the video data receiver 414 through the video connector 411 and the signal selector 412. Then, the video data receiver 414 receives the differential signal S42 and generates an image data D41 accordingly. Thus, the timing controller 418 receives the image data D41 and converts it into a display data D43. Finally, the image display module 419 displays an image corresponding to the display data D43.

However, the most obvious difference between the embodiment in FIG. 4 and the embodiment of FIG. 3 lies in that, the vide signal S45 is a digital video signal. The integrated display panel 410 functions as the intellectual display panel in response to the video signal S45 generated by the peripheral control module 430, and although the peripheral control signal S43 generated by the microprocessor 413 is still transmitted to the peripheral control module 430 through the signal selector 412 and the video connector 411, the video signal S45 generated by the peripheral control module 430 is transmitted to the image scaler 417 through the signal selector 412 and the video receiver 416. At this time, the signal selector 412 receives and outputs the video signal S45 according to the micro-control information S44. After that, the image scaler 417 scales the image corresponding to the output signal of the video receiver 416 and then generates an image data D42. At this time, the timing controller 418 receives the image data D42 and then converts it to a display data D43. Subsequently, the image display module 419 displays an image corresponding to the display data D43.

It should be mentioned that, the video signal S45 and a part of the differential signal S42 are transmitted through the same pin of the video connector 411. The video receiver 416 includes a DVI receiver. However, those skilled in the art may easily configure the video receiver 416 with other elements depending upon design requirements. Other details of this panel have already been described in the aforementioned embodiment, which thus will not be illustrated herein.

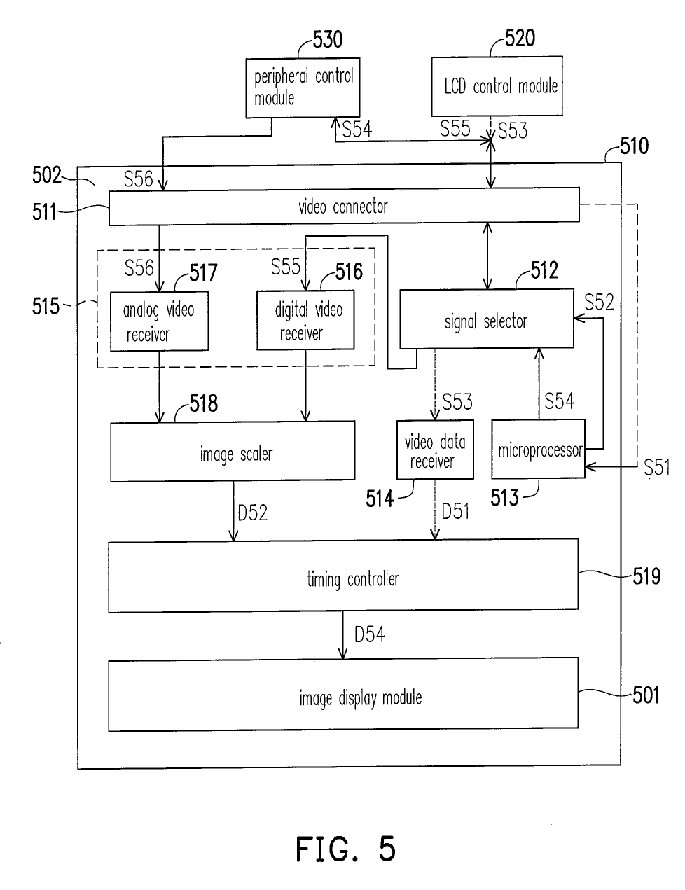

FIG. 5 is a block diagram of a structure of an integrated display panel according to still another embodiment of the present invention. Referring to FIG. 5, the integrated display 510 includes a video connector 511, a signal selector 512, a microprocessor 513, a video data receiver 514, a video receiver 515, an image scaler 518, a timing controller 519, and an image display module 501. The video receiver 515 further includes a digital video receiver 516 and an analog video receiver 517. The signal selector 512 is coupled to the microprocessor 513, a video connector 511 and a video receiver 515. The video data receiver 514 is coupled to the signal selector 512. The video receiver 515 is coupled to the signal connector 511. The image scaler 518 is coupled to the video receiver 515. The timing controller 519 is coupled to the video data receiver 514 and the image scaler 518. The image display module 501 is coupled to the timing controller 519. Additionally, the digital video receiver 516 is coupled to the signal selector 512 and the image scaler 518. The analog video receiver 517 is coupled to the video connector 511 and the image scaler 518. FIG. 5 also shows an LCD control module 520 and a peripheral control module 530.

The integrated display panel 510 further includes a substrate 502, wherein the video connector 511, the signal selector 512, the microprocessor 513, the video data receiver 514, the video receiver 515, the image scaler 518, the timing controller 519, and the image display module 501 are all disposed on the substrate 502.

It should be noted that, the digital video receiver 516 includes a DVI receiver, and the analog video receiver 517 includes a RGB receiver. However, those skilled in the art may easily configure the digital video receiver 516 and the analog video receiver 517 with other elements depending upon design requirements.

The working principle of the embodiment in FIG. 5 is substantially the same as that of the aforementioned two embodiments. When the integrated display panel 510 functions as the common display panel, the differential signal S53 is transmitted to the video data receiver 514 through the video connector 511 and the signal selector 512. Then, the video data receiver 514 receives the differential signal S53 and generates an image data D51 accordingly. Then, the timing controller 519 receives the image data D51 and converts it into a display data D54. Finally, the image display module 501 displays an image corresponding to the display data D54.

However, when the integrated display panel 510 functions as the intellectual display panel, in order to respond to the video signals, including the digital video signal S55 and the analog video signal S56, transmitted from the peripheral control module 530, the integrated display panel 510 is configured by integrating the two architectures mentioned in FIGS. 3 and 4. In other words, the peripheral control signal S54 generated by the microprocessor 513 is still transmitted to the peripheral control module 530 through the signal selector 512 and the video connector 511. However, in terms of the peripheral control module 530 used together with the integrated display panel 510, the integrated display panel 510 may have different transmission paths depending upon the video signals generated by the peripheral control module 530.

For example, when the video signal generated by the peripheral control module 530 is an analog video signal S56, the integrated display panel 510 transmits the analog video signal S56 to the image scaler 518 through the video connector 511 and the analog video receiver 517. After that, the image scaler 518 may scale the image corresponding to the output signal from the analog video receiver 517 and then generates an image data D52 accordingly. The timing controller 519 receives the image data D52 and converts it into a display data D54. Subsequently, the image display module 501 displays an image corresponding to the display data D54.

On the contrary, when the video signal generated by the peripheral control module 530 is a digital video signal S55, the integrated display panel 510 transmits the digital video signal S55 to the image scaler 518 through the video connector 511, the signal selector 512, and the digital video receiver 516. After that, the image scaler 518 scales the image corresponding to the output signal from the digital video receiver 516 and then generates an image data D52 accordingly. Similarly, the timing controller 519 receives the image data D52 and converts it into a display data D54. Finally, the image display module 501 displays an image corresponding to the display data D54.

It should be noted that, the video signal S55 and a part of the differential signal S53 are transmitted through the same pin of the video connector 511, and the peripheral control signal S54 and the differential signal S53 are also transmitted through a part of the same pin of the video connector 511. Other details of this panel have already been described in the aforementioned embodiments, and therefore they will not be described herein.

To sum up, the microprocessor is controlled through a mode switching signal, such that the integrated display panel is used together with an LCD control module or a peripheral control module. As such, the integrated display panel of the present invention is not only applicable for different client levels, but also integrates the display panel and reduces the system cost.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An integrated display panel, comprising:
a video connector, for transmitting a differential signal or a video signal;
a signal selector, coupled to the video connector, for determining whether or not to receive and output the differential signal according to a micro-control information;
an image scaler, coupled to one of the video connector and the signal selector, for scaling an image; and
a timing controller, coupled to the video connector and the image scaler, for converting the signal received by the timing controller to a display data.

2. The integrated display panel as claimed in claim 1, wherein the video signal comprises an analog video signal, and the integrated display panel comprises:
a video receiver, coupled to the video connector and the image scaler, for receiving the analog video signal.

3. The integrated display panel as claimed in claim 2, wherein the video receiver comprises a RGB receiver.

4. The integrated display panel as claimed in claim 1, wherein the video signal comprises a digital video signal, and the integrated display panel comprises:
a video receiver, coupled to the signal selector and the image scaler, for receiving the digital video signal;
wherein the signal selector further determines whether or not to receive and output the digital video signal according to the micro-control information.

5. The integrated display panel as claimed in claim 4, wherein the video receiver comprises a digital visual interface (DVI) receiver.

6. The integrated display panel as claimed in claim 4, wherein the digital video signal and a part of the differential signal are transmitted through the same pin of the video connector.

7. The integrated display panel as claimed in claim 1, further comprising:
a video data receiver, coupled to the signal selector and the timing controller, for receiving the differential signal.

8. The integrated display panel as claimed in claim 7, wherein the video data receiver comprises a low voltage differential signal (LVDS) receiver.

9. The integrated display panel as claimed in claim 1, further comprising:
a microprocessor, coupled to the signal selector, for generating the micro-control information according to a mode switching signal.

10. The integrated display panel as claimed in claim 9, wherein the video connector generates the mode switching signal according to the signal transmitted by the video connector.

11. The integrated display panel as claimed in claim 9, wherein the microprocessor further generates a peripheral control signal according to the mode switching signal, and the signal selector determines whether or not to receive and output the peripheral control signal according to the micro-control information, wherein the peripheral control signal and the differential signal are transmitted through a part of the same pin of the video connector.

12. The integrated display panel as claimed in claim 11, wherein the peripheral control signal comprises a volume control information and a backlight control information.

13. The integrated display panel as claimed in claim 1, further comprising:
an image display module, coupled to the timing controller, for displaying an image corresponding to the display data.

14. The integrated display panel as claimed in claim 13, wherein the display data comprises a gate drive data and a source drive data, and the image display module comprises:
a pixel array;
a gate drive circuit, for generating a gate signal for turning on/off the pixel array according to the gate drive data; and
a source drive circuit, for generating a source voltage for driving the pixel array according to the source drive data.

15. The integrated display panel as claimed in claim 1, further comprising a substrate, wherein the video connector, the signal selector, the image scaler, and the timing controller are disposed on the substrate.

16. The integrated display panel as claimed in claim 1, wherein the integrated display panel comprises a liquid crystal display (LCD) panel.

17. An integrated display panel, comprising:
a video connector, for transmitting a differential signal or a video signal;
a signal selector, coupled to the video connector, for determining whether or not to receive and output the differential signal or the video signal according to a micro-control information;
an image scaler, coupled to the video connector and the signal selector, for scaling the image; and
a timing controller, coupled to the video connector and the image scaler, for selecting one from the signals received by the timing controller and converting the selected signal to a display data.

18. The integrated display panel as claimed in claim 17, further comprising:
a video receiver, coupled to the image scaler, for receiving video signals from the video connector or the signal selector.

19. The integrated display panel as claimed in claim 18, wherein the video signals comprise an analog video signal and a digital video signal, and the video receiver comprises:
an analog video receiver, coupled to the video connector and the image scaler, for receiving the analog video signal; and
a digital video receiver, coupled to the signal selector and the image scaler, for receiving the digital video signal.

20. The integrated display panel as claimed in claim 19, wherein the digital video signal and a part of the differential signal are transmitted through the same pin of the video connector.

21. The integrated display panel as claimed in claim 19, wherein the analog video receiver comprises a RGB receiver, and the digital video receiver comprises a DVI receiver.

22. The integrated display panel as claimed in claim 17, further comprising:
a video data receiver, coupled to the signal selector and the timing controller, for receiving the differential signal.

23. The integrated display panel as claimed in claim 22, wherein the video data receiver comprises an LVDS receiver.

24. The integrated display panel as claimed in claim 17, further comprising:
a microprocessor, coupled to the signal selector, for generating the micro-control information according to a mode switching signal.

25. The integrated display panel as claimed in claim 24, wherein the video connector generates the mode switching signal according to the signal transmitted by the video connector.

26. The integrated display panel as claimed in claim 24, wherein the microprocessor further generates a peripheral control signal according to the mode switching signal, and the peripheral control signal and the differential signal are transmitted through a part of the same pin of the video connector.

27. The integrated display panel as claimed in claim 26, wherein the peripheral control signal comprises a volume control information and a backlight control information.

28. The integrated display panel as claimed in claim 17, further comprising:
an image display module, coupled to the timing controller, for displaying an image corresponding to the display data.

29. The integrated display panel as claimed in claim 28, wherein the display data comprises a gate drive data and a source drive data, and the image display module comprises:
a pixel array;
a gate drive circuit, for generating a gate signal for turning on/off the pixel array according to the gate drive data; and
a source drive circuit, for generating a source voltage for driving the pixel array according to the source drive data.

30. The integrated display panel as claimed in claim 17, further comprising a substrate, wherein the video connector, the signal selector, the image scaler, and the timing controller are disposed on the substrate.

31. The integrated display panel as claimed in claim 17, wherein the integrated display panel comprises an LCD panel.
